(19) United States
(12) Patent Application Publication
(10) Pub. No.: US 2002/0095829 A1
(43) Pub. Date: Jul. 25, 2002

(54) Identification tallies for mounting on coat hangers

(76) Inventor: Liu I-wen, Taipei (TW)

Correspondence Address: BACON & THOMAS, PLLC, 4th Floor, 625 Slaters Lane, Alexandria, VA, 22314-1176, US

(21) Appl. No.: 09/768,328

(22) Filed: Jan. 25, 2001

(51) Int. Cl. G09F 3/00

(52) U.S. Cl. 40/322

(57) ABSTRACT

Disclosed is to provide an identification tally for mounting on coat hanger, which comprises a circular or polygonal (preferably triangular and tetragonal) cylindrical portion having a circular loop located in the center of said cylindrical portion being bridgedly connected the outer edge of said cylindrical portion to the edge of said loop, can be integrally molded to form a cylindrical tally having an opening through the lug stem of a coat hanger may pass.

### TECHNICAL FIELD

This invention relates to identification tallies for mounting on coat hangers. More specially, this invention relates to size-indicating markers for use on coat hangers in order to indicate the size of the coats on display.

### BACKGROUND OF THE INVENTION

Various identification tallies have been devised heretofore to mount on coat hangers. One known identification tallies (1) in triangular cylinder as shown in FIG. 1, which has three sides (11), (11), (11) indicated or printed mark or numerals on both side. The said identification tallies (1) can be freely mounted onto the lug stem (21) of the coat hanger (2) to show the size of coat displayed, but this is merely the only kind to indicate. This is to say the usefulness is not enough.

UK Patent 2291036A describes a garment identification tally (as shown in FIG. 2 and FIG. 3) composed of an elongate strip of flexible material divided by transversely extending fold lines into three or more sections hingedly linked in end-to-end relationship, a number of the sections having an upstanding side wall extending along one of their respective side edges in a plane substantially perpendicular to the plane of the strip, and each side wall being substantially triangular in form having its base attached to a respective section and having a truncated apex, the marker being assembled by forming the sections of the marker into polygonal cylindrical array by bringing the sections at the respective ends of the strip into end-to-end engagement, the side walls defining at least one transverse surface relative to the axis of the garment marker. While such a marker is preferably held in its prismatic shape by means of cooperating latching elements formed on the end sections of the elongate strip. However, it is difficult to reopen the marker when once closed, and the exterior surfaces of the marker section make it difficult to print mark or numerals.

It is therefore necessary to have recourse to other means for affording such a measure. It is desirable to do without latching elements and retain the inherently advantageous fixation by way of an easily molded identification tallies. This invention seeks to solve this problem.

### GENERAL SUMMARY OF THE INVENTION

The object of this invention is to provide an identification tally composed of circular or polygonal (preferably triangular, tetragonal) cylindrical portion, which can be integrally molded to form a cylindrical tally having an opening through which the lug stem of a coat hanger may pass.

### BRIEF DESCRIPTION OF THE DRAWINGS

This invention will now particularly described in connection with the accompanying diagrammatic drawings, in which:

FIG. 1 is a simplified schematic diagram of an identification tally in the prior art;

FIG. 2 is a perspective view of a garment marker disclosed in the UK Patent 2291036A in its unassembled condition;

FIG. 3 is a perspective view of a garment marker disclosed in the UK Patent 2291036A in its assembled condition;

FIG. 4 is a perspective view of a tetragonal cylindrical identification tally having opening slot in one side according to this invention;.

FIG. 5 is a perspective view of a tetragonal cylindrical identification tally having opening slot in diagonally oriented direction according to this invention;

FIG. 6 is a perspective view of a triangular cylindrical identification tally having opening directed to an angle according to this invention;

FIG. 7 is a perspective view of a circular cylindrical identification tally having opening in one arc according to this invention; and

FIG. 8 is a perspective view of a circular cylindrical identification tally of FIG. 7 in its fitted condition onto the stem of coat hanger.

### DETAILED DESCRIPTION OF THE INVENTION

Referring now to the drawings, an identification tally comprises a circular or polygonal (preferably triangular, tetragonal) cylindrical portion, which can be integrally molded to form a cylindrical tally having an opening through which the lug stem of a coat hanger may pass.

From one aspect this invention consists in an identification tally for mounting on coat hanger, said tally being generally in the form of a right or polygonal (preferably triangular and tetragonal) cylinder having a circular loop located in the center of said cylinder being bridgedly connected the edge of said cylinder to the edge of said loop which can be integrally molded to form a cylindrical tally having an opening through the lug stem of a coat hanger may pass.

The identification tallies of this invention are preferably formed from plastics material, most preferably by injection, extrusion, pultrusion molding. The identification tallies may be color coded by coloring the plastics material, and the mark and numerals of the identification tallies are preferably applied by printing directly on to the surface of said tally.

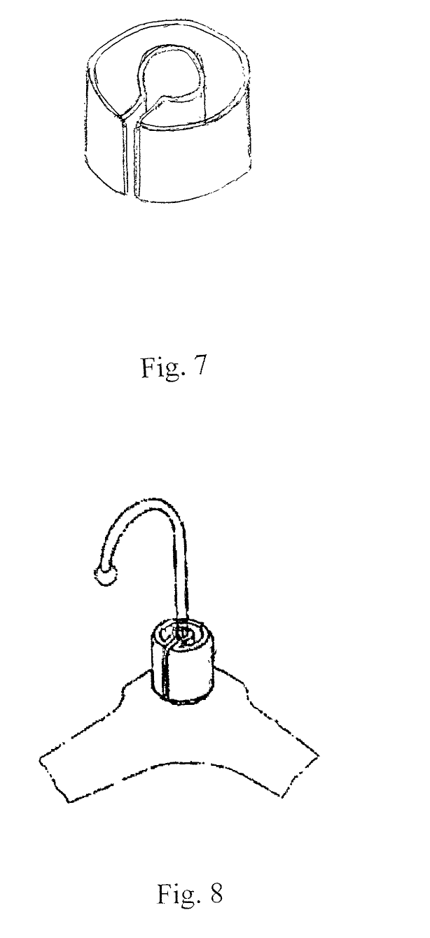

In the preferred embodiment, illustrated in FIG. 4, the opening slot 40 of the loop 41 located in the center of tetragonal cylinder (body portion) 4 directed to side 42, wherein the diameter of the loop is about ¼˜⅓ of the length of each side 42 of the tetragonal cylinder 4 or the diameter of the circular cylinder (see FIG. 7), which is bridgedly connected the side of said cylinder to the side. The above mentioned bridge portion 43 has a length about ⅓ of the side 42 or the diameter of the circular cylinder. The opening slot 40 has a width about ½˜⅓ of the diameter of the loop 41. For example, if the side of the tetragonal cylinder of the tally be 15 mm in length, the opening slot being 2.5˜3.0 mm in length, which is suitable to be opened to fit the diameter of the lug stem of the coat hanger (about 3˜4.5 mm).

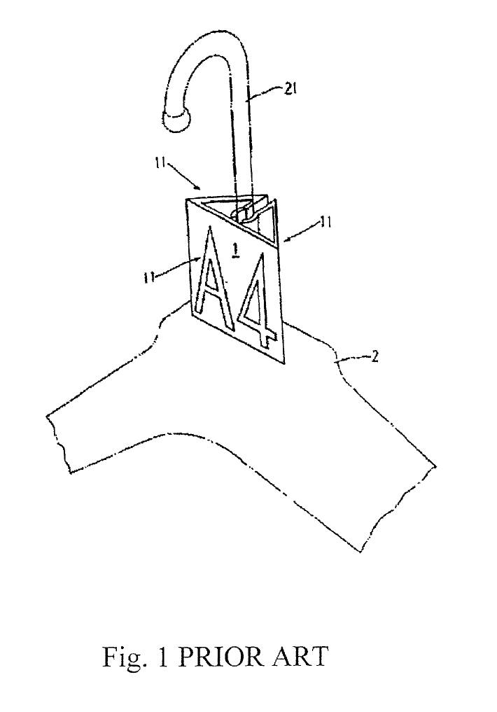

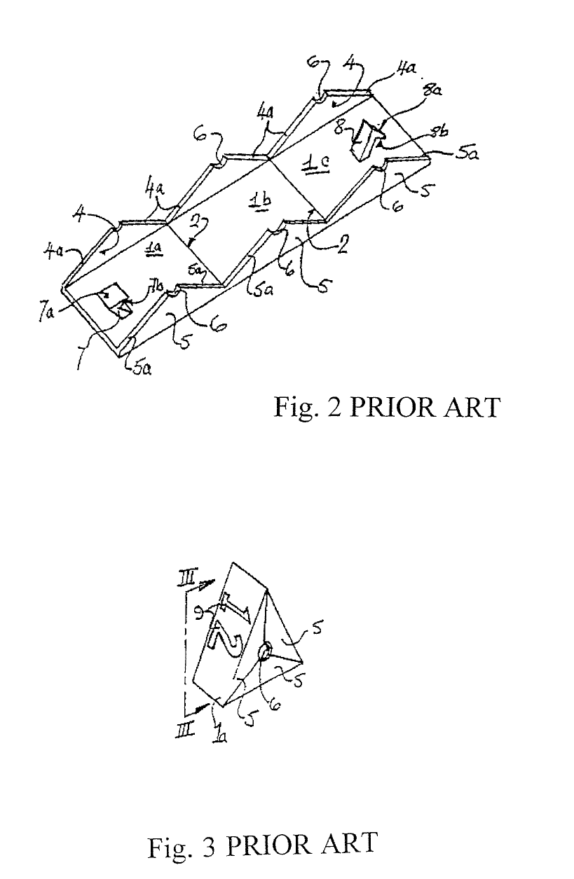

The opening slot of the tally in accordance with this invention, which is designed so that once it has been fitted onto a hanger, it can be easily removed therefrom only by opening the slot with thumb nail and pulling with hand, is particularly suitable for use in indicating size-mark to meet salesclerk's need. When the wings of the tally are opened to fit the lug stem of the coat hanger, these wings has repellant forces to recover to their original location, and this causes to firmly clipped themselves around the stem of the coat hanger, just like that of a butterfly clip do. The loop also acts as like that of expansion loop (joint) in the oil pipeline to counter the length change due to expansion or contraction. As the loop of the tally in accordance with this invention fits the lug stem of the coat hanger, it seems easier to apply to the coat hanger above the coat or garment on the hanger than conventional prior art (see FIG. 1) do, and in addition, it is also a better visual aid for the customer than prior art (see FIG. 8).

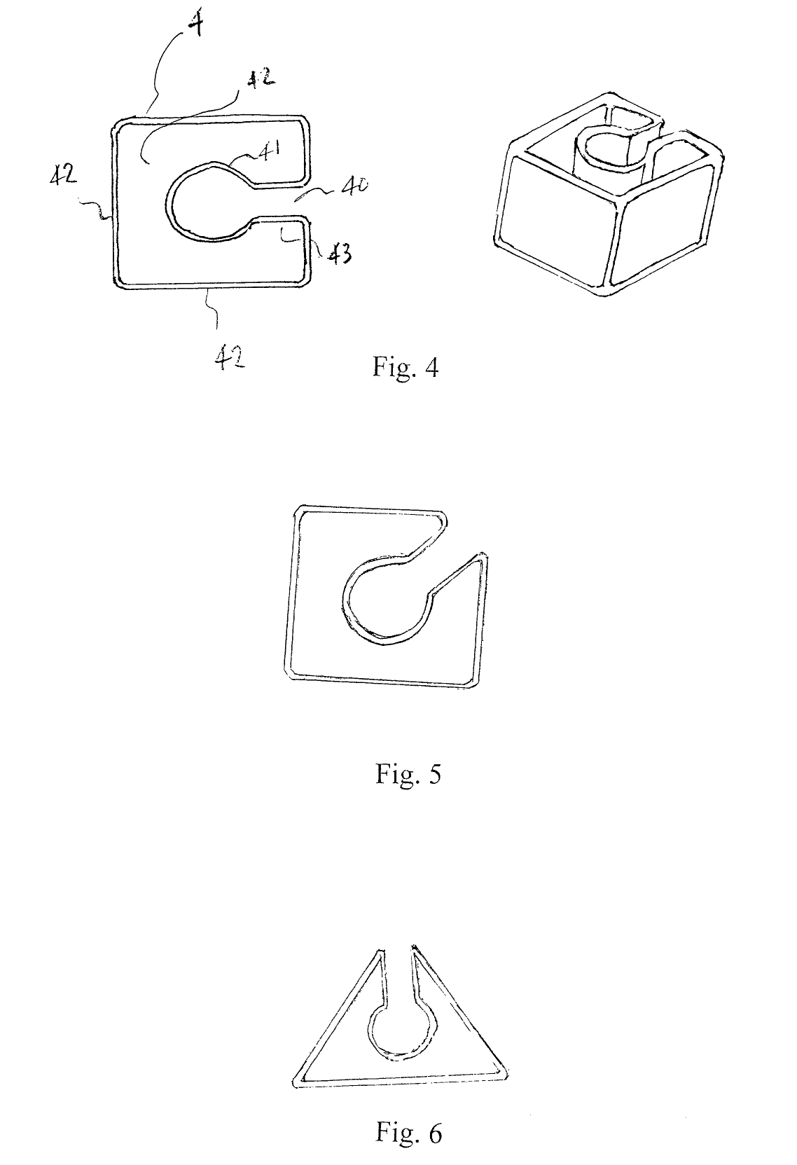

In the tally illustrated in FIG. 5, the tetragonal cylinder (body portion) 5 has an opening slot 50 oriented in diagonal direction according to this invention. As can be seen from FIG. 5, when the tally is in use, the two wings are clipped together around the lug stem of the coat hanger.

The modified shape illustrated in FIG. 6 and FIG. 7 show another triangular cylindrical tally and circular cylindrical tally in accordance with this invention. These tallies also have a circular loop located in the center of said cylinder being bridgedly connected the side of said cylinder to the edge of said loop which can be integrally molded to form a cylindrical tally having an opening through the lug stem of a coat hanger may pass. The diameter of the loop is about ¼˜⅓ of the length of each side of the triangular cylinder, which is bridgedly connected the side of said cylinder to the side. The above mentioned bridge portion has a length about ⅓ of the side. The opening slot has a width about ½˜⅓ of the diameter of the loop. In the position illustrated in FIG. 8, the two wings of the tally are held securely together. However, because of the width of the opening slot relative to the diameter of the lug stem of the coat hanger, and the nature of the material of the tally, the wings can be opened if sufficient force is applied thereto without damaging the tally. Thus, if desired, the tally can readily removed from one coat hanger and clipped onto another hanger.

While this invention has been illustrated in connection with a tally in the form of cylinder having a circular loop located in the center of said cylinder being bridgedly connected the edge of said cylinder to the edge of said loop, which can be integrally molded to form a cylindrical tally having an opening through the lug stem of a coat hanger may pass in the form of a circular or polygonal (preferably triangular and tetragonal) shape.

What is claimed is:

1. An identification tally for mounting on coat hanger, which comprises a circular or polygonal (preferably triangular and tetragonal) cylindrical portion having a circular loop located in the center of said cylindrical portion being bridgedly connected the outer edge of said cylindrical portion to the edge of said loop, can be integrally molded to form a cylindrical tally having an opening through the lug stem of a coat hanger may pass.

2. An identification tally as claimed in claim 1, wherein the diameter of said loop is about ¼˜⅓ of the length of each side of the polygonal cylinder or the diameter of the circular cylinder.

3. An identification tally as claimed in claim 1, wherein said bridged portion has a length about ⅓ of the length of each side of said polygonal cylinder of the circular cylinder.

4. An identification tally as claimed in claim 1, wherein said opening slot has a width about ½˜⅓ of the diameter of said loop.
